(19) United States
(12) Patent Application Publication
(10) Pub. No.: US 2026/0211508 A1
(43) Pub. Date: Jul. 23, 2026

(54) IN-VEHICLE IMMERSIVE-REALITY SYSTEM

(71) Applicant: Valeo Comfort and Driving Assistance, Créteil (FR)

(72) Inventors: Bruno Albesa, Créteil (FR); Ghaya Khemiri, Créteil (FR); Frederic Autran, Créteil (FR)

(73) Assignee: Valeo Comfort and Driving Assistance, Créteil (FR)

(21) Appl. No.: 19/142,513

(22) PCT Filed: Dec. 12, 2023
(86) PCT No.: PCT/EP2023/085322

§ 371 Date: Jun. 23, 2025

(30) Foreign Application Priority Data
Dec. 23, 2022 (FR) FR2214439

(51) Int. Cl. G06F 3/01; B60K 35/21; G02B 27/00; G02B 27/01; G06V 40/20

(52) U.S. Cl. CPC G06F 3/017; B60K 35/213; G02B 27/0093; G02B 27/017; G06V 40/28; B60K 2360/177; G02B 2027/0178

(57) ABSTRACT

Described is an immersive-reality system intended to be embedded on board a vehicle. The system includes a detector configured to detect a movement and/or an orientation and/or a position of the hands and/or of the head of a passenger. The detector includes a sensor installed in a fixed location in a passenger compartment of the vehicle. A display for displaying immersive-reality images is configured to be worn on the head of the passenger. The display is a head-mounted display or glasses configured to display images and to allow the passenger to see therethrough. A data-processing unit is configured to deliver immersive-reality images to the display, depending on data obtained by the detector, in order to allow hands to interact with an object in an immersive-reality scene displayed by the display.

The present invention notably relates to an immersive reality system, for example, a virtual reality system, intended to be installed on board a vehicle.

The vehicle can be a land vehicle, a marine vehicle or an air vehicle.

Patent application US2015378156 describes a virtual reality system in an actual vehicle. By virtue of this system, a vehicle vendor can arrive at the premises of a potential client with a test vehicle and the system can virtually display a configuration of the vehicle as requested by the client. The potential client can thus sit in the vehicle, become acquainted with the relevant materials of the test vehicle, specify an interior and any customized equipment, and touch the elements of the actual vehicle, for example, the steering wheel and the controls, while viewing the selected virtual configuration, by virtue of virtual reality glasses worn by the client.

Glasses are known from patent application DE102016225262 that can display an image on display surfaces in the field of view of the individual wearing the glasses. The display surfaces of the glasses can be semi-transparent, so that the real environment can be perceived as usual through the glasses and any information, such as text, symbols, graphics or video displays can be displayed by covering the perception of the environment. In order to have the spatial position of the data glasses in the coordinate system of the vehicle, as well as their three-dimensional orientation, a control unit is provided that is connected to a camera attached to a temple of the glasses and that is approximately directed toward the viewing direction of the individual wearing the glasses. The control unit evaluates the images of the camera and, using shape recognition methods, allows distinctive structures of the interior of the vehicle to be located in the camera image, with the positions of said structures being known, and allows the three-dimensional orientation of the glasses to be determined. The spatial positions and/or the movements of both hands of the individual wearing the data glasses are preferably determined when they are in the field of detection of the camera on the glasses.

Patent application US2016070966 describes a vehicle system that uses the position of the head of a driver as a measure for estimating the attention of the driver. The system can be configured to measure the position of the head of the driver with non-intrusive or intrusive methods. Non-intrusive measurement techniques can include, for example, interior cameras and image processing performed based on captured images of the head of the driver. Intrusive methods can include, for example, head-mounted devices configured to measure the orientation or the location of the head of the driver more directly. Intrusive methods for measuring the gaze of the driver can include glasses worn by the driver, which include motion sensors (for example, an accelerometer, a gyroscope) that the vehicle system can use to provide information for estimating the position of the head and the activity of the driver.

The invention notably aims to propose a new immersive reality system, for example, a virtual reality system, intended to be installed on board a vehicle.

Thus, the aim of the invention is an immersive reality system, for example, a virtual reality system, intended to be installed on board a vehicle, this system comprising:
a detection device configured to detect a movement and/or an orientation and/or a position of the hands and/or of the head of a passenger, preferably of a plurality of passengers on board the vehicle, with this detection device comprising at least one sensor installed in a fixed location in a passenger compartment of the vehicle;
a device for displaying immersive reality images configured to be worn on the head of a passenger, with this display device notably being a head-mounted display (or HMD) or glasses configured to display images and to allow the passenger to see therethrough;
a data processing unit configured to provide the display device with immersive reality images, based on data obtained by the detection device, notably to allow the hands to interact with an object in an immersive reality scene displayed by the display device.

The term “passenger” can designate the driver themselves or an individual sitting next to the driver, or in the rear of the vehicle.

According to one of the aspects of the invention, the detection device is configured to be able to detect a movement and/or an orientation and/or a position of the hands and/or of the head of a passenger located anywhere in the passenger compartment. For example, the detection device is configured to be able to detect a movement and/or an orientation and/or a position of the hands and/or of the head of a passenger located in a place in the front or in the rear of the vehicle.

According to one of the aspects of the invention, the detection device comprises a plurality of sensors fixed in the passenger compartment, at several locations in the passenger compartment, so as to be able to detect a movement and/or an orientation and/or a position of the hands and/or of the head of a passenger anywhere in the passenger compartment. These sensors can be identical or, as a variant, can be different, combining, for example, a three-dimensional type sensor and a two-dimensional type sensor. The system can comprise, if applicable, a plurality of three-dimensional sensors in order to cover the whole passenger compartment by providing several viewpoints that complement each other. Similarly, the system can comprise, if applicable, a plurality of two-dimensional sensors in order to cover the whole passenger compartment by providing several viewpoints that complement each other.

According to one of the aspects of the invention, the detection device is configured to be able to detect a movement and/or an orientation and/or a position of the hands and/or of the head of a plurality of passengers simultaneously, with said passengers being located in the passenger compartment, whether they are on the front seats or on the rear seats.

In the invention, the detection device and the display device are mechanically separate from each other, namely, the sensor of the detection device is not mechanically linked to the display device, unlike some virtual reality devices in which the head-mounted display integrates sensors for determining the position, the orientation and the movement of the individual wearing the head-mounted display. In the invention, the one or more sensors of the detection device is/are placed at fixed locations in the passenger compartment, so that these sensors are capable of detecting the position, the orientation and the movement of parts of the body (head and hands, in particular) of passengers in the passenger compartment, while avoiding having to manage blind spots that remain when the sensors are integrated in the head-mounted display. In some respects, the one or more sensors placed, according to the invention, at suitable locations in the passenger compartment, allow 360° detection in the passenger compartment, where sensors integrated in conventional head-mounted displays do not generally allow any detection in a zone behind the head-mounted display.

The invention also dispenses with the need for joysticks for interacting with objects in the virtual environment, by virtue of the sensors placed in the passenger compartment around the one or more passengers, which sensors directly detect the gestures of the hands.

The sensors mounted in the passenger compartment can be used for several passengers simultaneously. In contrast, if the one or more sensors were mounted on the head-mounted display, then as many groups of sensors would be required as there are headsets to monitor. The invention thus allows the sensors to be pooled for several head-mounted displays or glasses.

Advantageously, the device for displaying immersive reality images is devoid of a sensor for detecting the movement and/or the orientation and/or the position of the head or of the hands. All these sensors are placed at fixed locations in the passenger compartment.

According to one of the aspects of the invention, the sensor of the detection device is configured to provide a three-dimensional image of a detection zone. This is preferred for detecting the position, the orientation and the movement of the hands of the passenger.

According to one of the aspects of the invention, the sensor of the detection device is selected from among:
a time-of-flight sensor, such as a Time-of-Flight (TOF) camera adapted to send light to the passenger and to measure the time taken by this light to return to said time-of-flight sensor in order to ascertain the three-dimensional image in a detection zone;
a stereoscopic sensor comprising at least two cameras, each capturing an image of a detection zone from its own viewpoint, with the images of each camera then being combined in order to ascertain a three-dimensional image of the detection zone;
a structured light sensor adapted to project a pattern onto the detection zone and to analyze the deformation of this pattern in order to ascertain the three-dimensional image of the driver.

According to another aspect of the invention, the sensor of the detection device is configured to provide a two-dimensional image of a detection zone. This is adapted to detect the position, the orientation and the movement of the head of the passenger.

According to one of the aspects of the invention, the sensor of the detection device is an RGB camera, or an infrared camera, notably of the near infrared (or NIR) type.

According to one of the aspects of the invention, the detection device comprises a plurality of sensors selected from among the sensors described above, which notably include at least one two-dimensional detection sensor and one three-dimensional detection sensor. The two-dimensional detection sensor advantageously can be used to locally increase the resolution of the three-dimensional detection sensor.

According to one of the aspects of the invention, the sensor is positioned on a ceiling of the vehicle, notably in front ceiling lighting of the vehicle.

As a variant, the sensor is disposed in a lower portion of the windshield of the vehicle, notably substantially in front of the driver.

According to one of the aspects of the invention, the one or more sensors is/are placed on a dashboard of the vehicle, notably in a central zone of this dashboard. It is also possible for the one or more sensors to be placed on a rear-view mirror of the vehicle, notably integrated on the central rear-view mirror inside the passenger compartment.

According to one of the aspects of the invention, the immersive reality system is configured to allow the passenger wearing the immersive reality display device to interact with an object in the virtual environment or in the real environment, notably with a hand, for example, by touching it with a hand or by gripping it with a hand.

The invention thus allows, by virtue of the one or more sensors mounted in the passenger compartment, accurate and extensive detection (for example, 360°) of the hands of the one or more passengers for the purposes of managing virtual reality interactions.

According to one of the aspects of the invention, the immersive reality system is configured to generate a fully virtual environment that is perceptible in the virtual reality head-mounted display, which is completely occulting, namely, the real environment is completely occluded.

In this system according to the invention, it is possible, while being fully immersed in the virtual environment, to turn the head around 360°, to move in the space and to interact with the virtual environment using the hands, the movements of which are detected by the one or more sensors of the detection device.

According to another aspect of the invention, the immersive reality system is configured to generate an augmented reality environment in which virtual three-dimensional or two-dimensional elements are superimposed on a real environment.

According to another aspect of the invention, the immersive reality system is configured to generate an augmented reality environment additionally allowing interaction between a virtual environment and a real environment. This type of system is also called mixed reality system.

In other words, in a mixed reality application, virtual three-dimensional or two-dimensional elements are superimposed on a real environment (augmented reality) and interaction with the virtual elements is possible, notably by means of hand gestures, as in virtual reality.

According to one of the aspects of the invention, the immersive reality system is configured to operate entertainment or a relaxation session intended for the passenger wearing the display device, which passenger can interact, notably with their hands, with a virtual entertainment or relaxation environment.

According to another aspect of the invention, the immersive reality system can be used in order to learn to drive a vehicle or for marketing promotions for a vehicle.

In the present invention, a head-mounted display is a display device worn on the head or in a headset of the passenger, comprising a display screen opposite an eye (monocular head-mounted display), or two display screens opposite each eye (binocular head-mounted display).

The display screens are miniaturized and can be, for example, liquid crystal display (LCD) screens, liquid crystal on silicon (LCOS) screens, or organic light emitting diode (OLED) screens.

According to one of the aspects of the invention, the data processing unit is connected to the display device by means of wires.

As a variant, the data processing unit is wirelessly connected to the display device, notably by means of a Bluetooth or Wi-Fi wireless communication protocol.

According to one of the aspects of the invention, the data processing unit forms part of an on-board computer of the vehicle.

According to another aspect of the invention, the data processing unit is integrated into the display device. Thus, for example, the head-mounted display can include the data processing unit that communicates with the sensors and performs the computations for determining the interactions between, for example, the hands of the passenger and the immersive reality scene.

A further aim of the invention is a method for managing an immersive reality system, for example, a virtual reality system, installed on board a vehicle, this method comprising the following steps:
detecting a movement and/or an orientation and/or a position of the hands and/or of the head of a passenger, preferably of a plurality of passengers on board the vehicle, using a detection device of the immersive reality system, comprising at least one sensor installed in a fixed location in a passenger compartment of the vehicle;
displaying immersive reality images in a display device of the system, worn on the head of a passenger, based on data obtained by the detection device, notably to allow the hands to interact with an object in an immersive reality scene displayed by the display device.

According to one of the aspects of the invention, the immersive reality scene is a virtual reproduction of the passenger compartment of the vehicle. Thus, the passenger can be immersed in the environment of the vehicle, with this virtual scene including additional virtual objects, for example, dedicated to entertainment (for example, a virtual pencil for drawing) or a relaxation session (for example, a virtual ball that the passenger can grasp).

The virtual reality scene can contain an image of another passenger. Thus, two or more individuals in the passenger compartment can interact in the virtual reality world.

The sensors installed in the passenger compartment allow the movements of all the passengers seated in the vehicle to be detected.

The invention is particularly well suited to an autonomous driving vehicle. This allows the passengers, including the driver, to enjoy the immersive reality system, without having to focus on driving the vehicle.

Further features and advantages of the invention will become more clearly apparent upon reading the following description, which is provided by way of a non-limiting illustrative example, and from the appended drawing, in which:

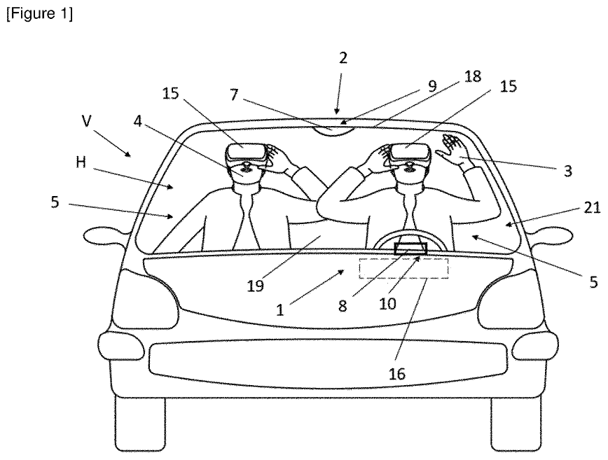

FIG. 1 schematically and partially illustrates an immersive reality system intended to be installed on board a vehicle, according to one embodiment of the invention.

FIG. 1 shows an immersive reality system 1, in this case a virtual reality system, intended to be installed on board a vehicle V, with this system 1 comprising:
a detection device 2 configured to detect a movement and/or an orientation and/or a position of the hands 3 and/or of the head 4 of a plurality of passengers 5 on board the vehicle V, with this detection device 2 comprising sensors 7 and 8 installed at fixed locations, respectively 9 and 10, in a passenger compartment H of the vehicle V;
a device 15 for displaying immersive reality images configured to be worn on the head of a passenger 5, with this display device in this case being a head-mounted display (or HMD);
a data processing unit 16 configured to provide the display device 15 with immersive reality images, based on data obtained by the detection device 2, notably to allow the hands 3 to interact with an object in an immersive reality scene displayed by the display device 15.

The term “passenger” can designate the driver themselves or an individual sitting next to the driver, or in the rear of the vehicle.

The detection device 2 is configured to be able to detect a movement and/or an orientation and/or a position of the hands and/or of the head of a passenger 5 located in a place in the front or in the rear of the vehicle.

The sensors 7 and 8 fixed in the passenger compartment are located at several locations, 9 and 10, respectively, in the passenger compartment, so as to be able to detect a movement and/or an orientation and/or a position of the hands and/or of the head of a passenger anywhere in the passenger compartment.

The sensor 7 is positioned at a location 9 in the ceiling 18 of the vehicle, notably in front ceiling lighting of the vehicle or a dome.

The sensor 8 is disposed in a lower portion 10 of the windshield 19 of the vehicle, notably substantially in front of the driver. As a variant, a camera-type sensor 8 can be integrated into the central rear-view mirror.

The detection device 2 is configured to be able to detect a movement and/or an orientation and/or a position of the hands and/or of the head of a plurality of passengers 5 simultaneously, with said passengers being located in the passenger compartment, whether they are on the front seats or on the rear seats.

The detection device 2 and the display device 15 are mechanically separate from each other, namely, the sensor of the detection device is not mechanically linked to the display device, unlike some virtual reality devices in which the head-mounted display integrates sensors for determining the position, the orientation and the movement of the individual wearing the head-mounted display.

The device 15 for displaying immersive reality images is devoid of a sensor for detecting the movement and/or the orientation and/or the position of the head 4 or of the hands 3.

The sensor 7 of the detection device 2 is configured to provide a three-dimensional image of a detection zone 21, which is the entire passenger compartment H.

The sensor 7 is selected from among:
a time-of-flight sensor, such as a Time-of-Flight (TOF) camera adapted to send light to the passenger and to measure the time taken by this light to return to said time-of-flight sensor in order to ascertain the three-dimensional image in a detection zone;
a stereoscopic sensor comprising at least two cameras, each capturing an image of a detection zone from its own viewpoint, with the images of each camera then being combined in order to ascertain a three-dimensional image of the detection zone;
a structured light sensor adapted to project a pattern onto the detection zone and to analyze the deformation of this pattern in order to ascertain the three-dimensional image of the driver.

The sensor 8 is configured to provide a two-dimensional image of the detection zone 21.

The sensor 8 is an RGB camera, or an infrared camera, notably of the near infrared (or NIR) type.

The immersive reality system 1 is configured to allow the passenger 5 wearing the immersive reality display device 16 to interact with an object in the virtual environment or in the real environment, notably with a hand, for example, by touching it with a hand or by gripping it with a hand.

The immersive reality system 1 is configured to generate a fully virtual environment that is perceptible in the virtual reality head-mounted display 16, which is completely occulting, namely, the real environment is completely occluded.

In this system according to the invention, it is possible, while being fully immersed in the virtual environment, to turn the head around 360°, to move in the space and to interact with the virtual environment using the hands, the movements of which are detected by the one or more sensors of the detection device.

As a variant, the immersive reality system could be configured to generate an augmented reality or mixed reality environment, in which virtual three-dimensional or two-dimensional elements are superimposed on a real environment.

As required, the immersive reality system is configured to generate an augmented reality or mixed reality environment additionally allowing interaction between a virtual environment and a real environment.

The immersive reality system 1 is configured to operate entertainment or a relaxation session intended for the passenger 5 wearing the display device 16, which passenger 5 can interact, notably with their hands, with a virtual entertainment or relaxation environment.

The immersive reality system 1 can be used in order to learn to drive a vehicle or for marketing promotions for a vehicle.

The head-mounted display 15 is a display device worn on the head or in a headset of the passenger 5, comprising a display screen opposite an eye (monocular head-mounted display), or two display screens opposite each eye (binocular head-mounted display). The head-mounted display can be completely occluding (opaque) or see-through, as required.

The display screens are miniaturized and can be, for example, liquid crystal display (LCD) screens, liquid crystal on silicon (LCOS) screens, or organic light emitting diode (OLED) screens.

The data processing unit 16 is connected to the display device 15 by means of wires.

As a variant, the data processing unit 16 is wirelessly connected to the display device 15, notably by means of a Bluetooth or Wi-Fi wireless communication protocol.

For example, the data processing unit 16 forms part of an on-board computer of the vehicle.

It is also possible for the data processing unit 16 to be integrated into the display device 15. Thus, for example, the head-mounted display 15 can include the data processing unit 16 that communicates with the sensors 7 and 8 and performs the computations for determining the interactions between, for example, the hands 3 of the passenger and the immersive reality scene.

In the described example, the immersive reality scene is a virtual reproduction of the passenger compartment H of the vehicle. Thus, the passenger 5 can be immersed in the environment of the vehicle, with this virtual scene including additional virtual objects, for example, dedicated to entertainment (for example, a virtual pencil for drawing) or a relaxation session (for example, a virtual ball that the passenger can grasp).

The virtual reality scene can contain an image of another passenger. Thus, two or more individuals in the passenger compartment can interact in the virtual reality world.

The sensors 7 and 8 installed in the passenger compartment H allow the movements of all the passengers seated in the vehicle to be detected.

The invention is particularly well suited to an autonomous driving vehicle. This allows the passengers, including the driver, to enjoy the immersive reality system, without having to focus on driving the vehicle.

1. An immersive reality system system to be installed on board a vehicle, comprising:
a detection device configured to detect a movement and/or an orientation and/or a position of the hands and/or of the head of a passenger, the detection device comprising at least one sensor installed in a fixed location in a passenger compartment of the vehicle;
a display device for displaying immersive reality images configured to be worn on the head of a passenger, wherein the display device is a head-mounted display or glasses configured to display images and to allow the passenger to see therethrough; and
a data processing unit configured to provide the display device with immersive reality images, based on data obtained by the detection device, to allow the hands to interact with an object in an immersive reality scene displayed by the display device.

2. The immersive reality system as claimed in claim 1, wherein the detection device comprises a plurality of sensors fixed in the passenger compartment, at several locations in the passenger compartment, so as to be able to detect a movement and/or an orientation and/or a position of the hands and/or of the head of a passenger anywhere in the passenger compartment.

3. The immersive reality system as claimed in claim 1, wherein the detection device is configured to be able to detect a movement and/or an orientation and/or a position of the hands and/or of the head of a plurality of passengers simultaneously, with the plurality of passengers being located in the passenger compartment, whether they are on the front seats or on the rear seats.

4. The immersive reality system as claimed in claim 1, wherein the device for displaying immersive reality images is devoid of a sensor for detecting the movement and/or the orientation and/or the position of the head or of the hands.

5. The immersive reality system as claimed in claim 1, wherein the at least one sensor of the detection device is configured to provide a three-dimensional image of a detection zone.

6. The immersive reality system as claimed in claim 5, wherein the sensor of the detection device is selected from among:
a time-of-flight sensor adapted to send light to the passenger and to measure a time taken by the light to return to the time-of-flight sensor in order to ascertain the three-dimensional image in a detection zone;
a stereoscopic sensor comprising at least two cameras, each capturing an image of a detection zone from its own viewpoint, with the images of each camera then being combined in order to ascertain a three-dimensional image of the detection zone; and
a structured light sensor adapted to project a pattern onto the detection zone and to analyze the deformation of this pattern in order to ascertain the three-dimensional image of the driver.

7. The immersive reality system as claimed in claim 1, wherein the at least one sensor of the detection device is configured to provide a two-dimensional image of a detection zone.

8. The immersive reality system as claimed in claim 1, wherein the at least one sensor is positioned on a ceiling of the vehicle in front ceiling lighting of the vehicle.

9. The immersive reality system as claimed in claim 1, wherein the at least one sensor is disposed in a lower part of a windshield of the vehicle substantially in front of the driver.

10. The immersive reality system as claimed in claim 1, wherein the immersive reality system is configured to allow the passenger wearing the immersive reality display device to interact with an object in the virtual environment or in the real environment.

11. The immersive reality system as claimed in claim 1, wherein the immersive reality system is configured to generate a fully virtual environment that is perceptible in a virtual reality head-mounted display, which is completely occulting.

12. The immersive reality system as claimed in claim 1, wherein the immersive reality system is configured to generate an augmented reality environment in which virtual three-dimensional or two-dimensional elements are superimposed on a real environment.

13. The immersive reality system as claimed in claim 12, wherein the immersive reality system is configured to generate an augmented reality environment additionally allowing interaction between a virtual environment and a real environment.

14. The immersive reality system as claimed in claim 1, wherein the immersive reality system is configured to operate entertainment or a relaxation session intended for the passenger wearing the display device, which passenger can interact, with their hands, with a virtual entertainment or relaxation environment.

15. A method for managing an immersive reality system installed on board a vehicle, comprising
detecting a movement and/or an orientation and/or a position of the hands and/or of the head of a passenger on board the vehicle, using a detection device of the immersive reality system, comprising at least one sensor installed in a fixed location in a passenger compartment of the vehicle;
displaying immersive reality images in a display device of the system, worn on the head of the passenger, based on data obtained by the detection device, to allow the hands to interact with an object in an immersive reality scene displayed by the display device.
